(19) United States
(12) Patent Application Publication
(10) Pub. No.: US 2005/0037662 A1
(43) Pub. Date: Feb. 17, 2005

(54) Exchangeable module for an electric system

(75) Inventors: Shark Sheng, Shenzhen City (CN); Chih-Hsin Chin, Taipei (TW); Windy Wang, Shenzhen City (CN)

Correspondence Address: Cooper & Dunham LLP, 1185 Avenue of the Americas, New York, NY, 10036, US

(73) Assignee: Phoenixtec Power Co., Ltd.

(21) Appl. No.: 10/653,481

(22) Filed: Sep. 2, 2003

(51) Int. Cl. H01R 31/08

(52) U.S. Cl. 439/507

(57) ABSTRACT

An exchangeable module or battery 20 is wired to null terminals a, c. A main device 30 is joined to circuit terminals b, d. A connector 10 with a pair of shunt plates 11, 12 is used to electrically connect terminal a to be and terminal c to d, in order to connect the battery to the main device. The connector may be mounted in a cover panel 42, 43.

### BACKGROUND OF THE INVENTION

1. Field of the Invention

The present invention relates to an exchangeable module for an electric system and more particularly to an exchangeable module that easily and safely is replaced from the electric system.

2. Description of Related Art

The European standard “EN60950: Safety of Information Technology Equipment” stipulates protection in operator access areas in EN60950 2.1.1. EN60950 1.2.8.2 defines a primary circuit is directly connected to the AC main supply, and EN60950 1.2.8.3 defines a secondary circuit has no direct connection to a primary circuit and derives its power from a transformer, converter or equivalent isolation device, or from battery. Power supplied to a secondary circuit is provided through a transformer, a current transformer or insolating circuit. According to the standard, to protect the operator from hazards, a common safety design in operator access areas is the Safety Extra Low Voltage (SELV) circuit that has reinforced insulation from primary circuit. This device is insulation type electronic device. However the reinforced insulation is complex and is hard to design, so the cost of this device is very high. Another common safety design uses a safety interlock by a hardware device to prevent a user from directly touching the primary circuit. This device is a Primary type electronic device. Based on this, a space for reinforce insulation between the operator access area and the primary circuit is required when the operator replace the internal power. Therefore the hardware device is also very complex and hard to design.

Electronic modules used more often recently to add or extend capabilities of parent electronic devices necessitate the use of Safety of Information Technology Equipment to ensure safe operation. Many electronic devices provide convenient means to connect electronic modules. However, some electronic modules are primary circuits, and Safety of Information Technology Equipment is required in the parent electronic device to protect users. For example, an uninterruptible power supply (UPS) basically has a primary circuit and battery modules. The battery modules have a useful life and must be periodically replaced in many cases without deactivating the UPS. This necessitates replacing the battery modules when the UPS is “hot” to maintain normal operation of the equipment attached to the UPS. In general, the design of the UPS comprises one of the following features:
(1) The battery charger circuit is designed as a safety extra low voltage circuit, so as to the insulated transformer is needed.
(2) Using a battery connector with reinforced insulation between the part where the user can touch and charger circuit (a primary circuit) when replace the battery modules.
   However, the first feature requires an extra power converter circuits that use a significant amount of space in the UPS and the cost is up. As for the second feature, the reinforced insulation required the connector to meet the safety requirements. Meanwhile, because all the power is come from battery when UPS operates in reverse mode, the current rating of the connector is so high. This also causes the cost to go up significantly.

With reference to FIG. 8, a conventional connector (90) to connect the battery module (70) to the circuit (80) of the UPS (60) has a socket (91) and a plug (92). The plug (92) attaches to or detaches from the socket (91) to connect or disconnect the battery module (70) and circuit (80). The user has to manually connect or disconnect the connector (90) so as to a cheap connector (90) without reinforced insulation to the operator can be very dangerous.

The present invention provides a power source connector to mitigate or obviate the aforementioned problems.

### SUMMARY OF THE INVENTION

The objective of the present invention is to provide an exchangeable module for an electronic. The exchangeable module can easily and safely replace an internal power source in the electric device.

Another objective of the present invention is to provide a low cost internal electric connecting device without complex circuit or expensive insulation transformers for an exchangeable module.

Other objectives, advantages and novel features of the invention will become more apparent from the following detailed description when taken in conjunction with the accompanying drawings.

### BRIEF DESCRIPTION OF THE DRAWINGS

FIGS. 1A and 1B are wiring drawings of terminals on a main electric device and an exchangeable module in an electric system in accordance with the present invention;

FIGS. 2A and 2B are wiring drawings of terminals on a main electric device and an exchangeable module in an electric system in accordance with the present invention;

FIG. 3 is an exploded perspective view of an uninterruptible power supply (UPS) with a battery module in accordance with the present invention;

FIGS. 4A and 4B are cross sectional side plan views of a main electric device connected the battery module in FIG. 3;

FIG. 5 is a cross sectional side plane view of a main electric device and the battery module in accordance with the present invention;

FIG. 6 is an exploded perspective view of another electric system having an exchangeable module in accordance with the present invention;

FIG. 7 is a perspective view of the electronic system in FIG. 6; and

FIG. 8 is a wiring drawing of a conventional power source connector.

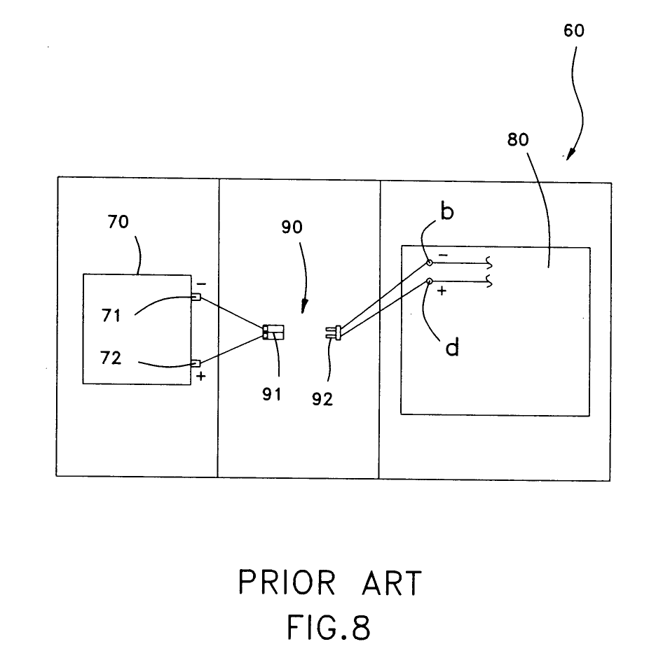

### DETAILED DESCRIPTION OF THE PREFERRED EMBODIMENT

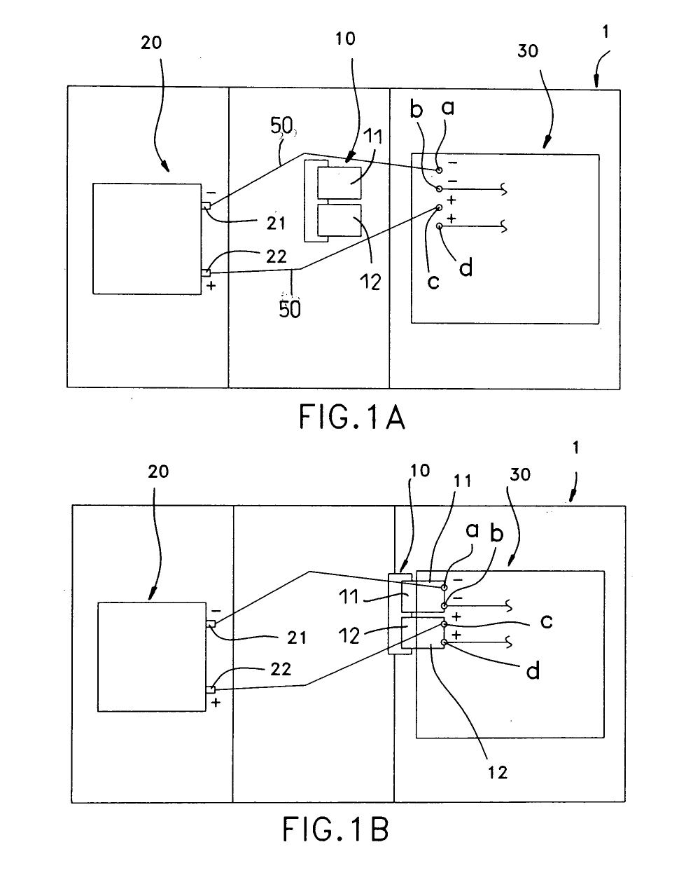

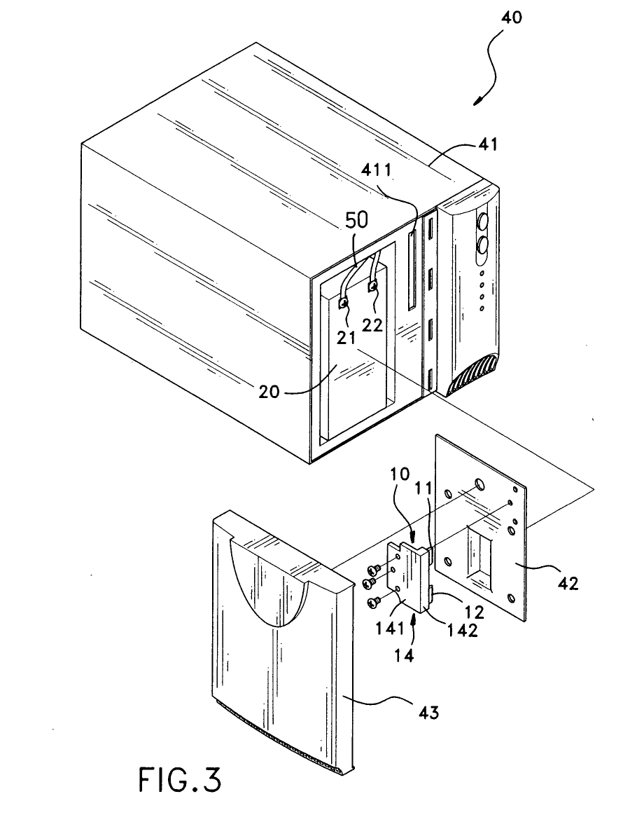

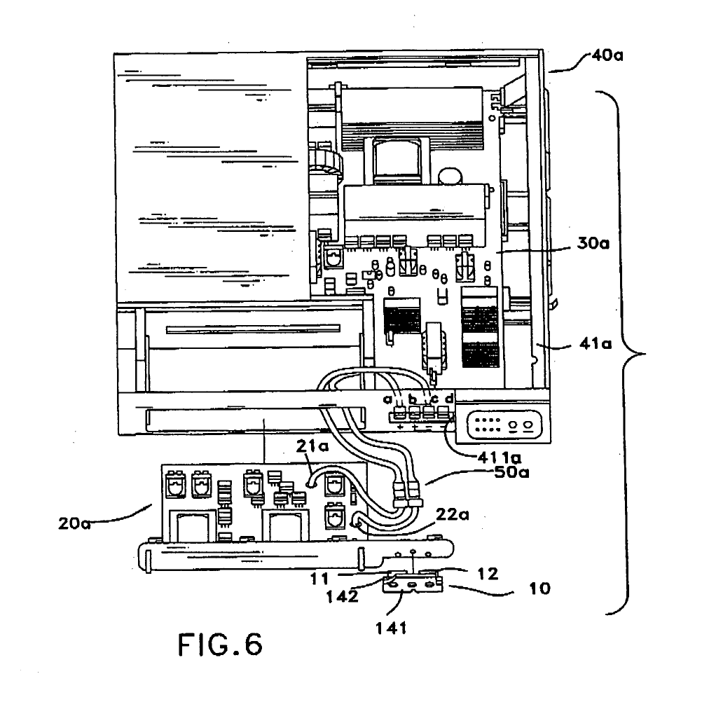

With reference to FIG. 1, an electric system (1) includes a main electric device (30) retained in a case (not numbered), an exchangeable electric module (20) separately connected to the case and a conductive device (10) separately connected terminals on the main electric module (20). A portion of the conductive device (10) is connected to the exchangeable electric module (20), as shown in FIG. 3 or FIG. 6. Therefore, a user can conveniently short or open the electric connection between the terminals (a, b, c, d) on the main electric device (30) in the case. The exchangeable electric module (20) has a connector (50) as a wire set connected together between the main electric device (30) and the exchangeable electric module (20). The exchangeable module (20) is able to be a battery module, a power module or a specific function controlled module.

With reference to FIG. 1A, the first embodiment of the present invention is shown. The exchangeable module (10) is a battery module and the main electric device (30) is a printed circuit board (PCB) and the connector is a wire set having two wires. Each wire is connected between the battery module and the PCB.

The battery module (10) has at least one negative power terminal (21) and one positive power terminal (22). The main electric device (30) has multiple null terminals (a, c) respectively connected to each power terminal (21, 22) by the wires. A first null terminal (a) on the electronic circuit (30) is securely connected to the negative power terminal (21) on the battery module (20), and a second null terminal (c) on the electronic circuit (30) is securely connected to the positive power terminal (22) on the battery module (20). With the null terminals (a, c) hard-wired to the battery module (20), the first null terminal (a) has a negative potential (−), and the second null terminal (c) has a positive potential (+). A negative circuit terminal (b) and a positive circuit terminal (d) are formed on the electronic circuit (30) respectively corresponding to the first and second null terminals (a, c). The null terminals (a, c) and the circuit terminals (b, d) are positioned in a line in corresponding pairs (a-b, c-d) with an equal distance between the null and circuit terminals (a-b, c-d) of each pair.

The conductive device (10) has a conductive switch plate (11, 12) corresponding to each pair of terminals on the electronic circuit (30). Each conductive switch plate (11, 12) is essentially rectangular with a length and a width and connects to a null and circuit terminal pair (a-b, c-d) with the same electrical characteristic, for example both positive or both negative.

The width of each conductive switch plate (11, 12) is wider than the distance between adjacent terminals in each pair of null and circuit terminals on the electronic circuit (30). Each conductive switch plate (11, 12) is used to connect the null and circuit terminal in each pair (a-b, c-d).

With reference to FIG. 1B, the appropriate electrical potential is applied to the corresponding circuit terminal (b, d) by connecting the null and circuit terminal in each pair (a-b, c-d) since the null terminals (a, c) are hard-wired to the corresponding power terminals (21, 22) on the battery module (20). When the internal battery module (20) needs to be disconnected from the main electric circuit (30), the conductive device (10) only needs to be moved from the main electric circuit (30) to disconnect the null and circuit terminals (a, b, c, d) on the electronic circuit (30). The power between the battery module (20) and the main electric circuit (30) is interrupted on the main electric circuit (30) so a user can safely replace a battery module (20) in the electronic system (1) without securing external power (not shown) to the electronic system (1).

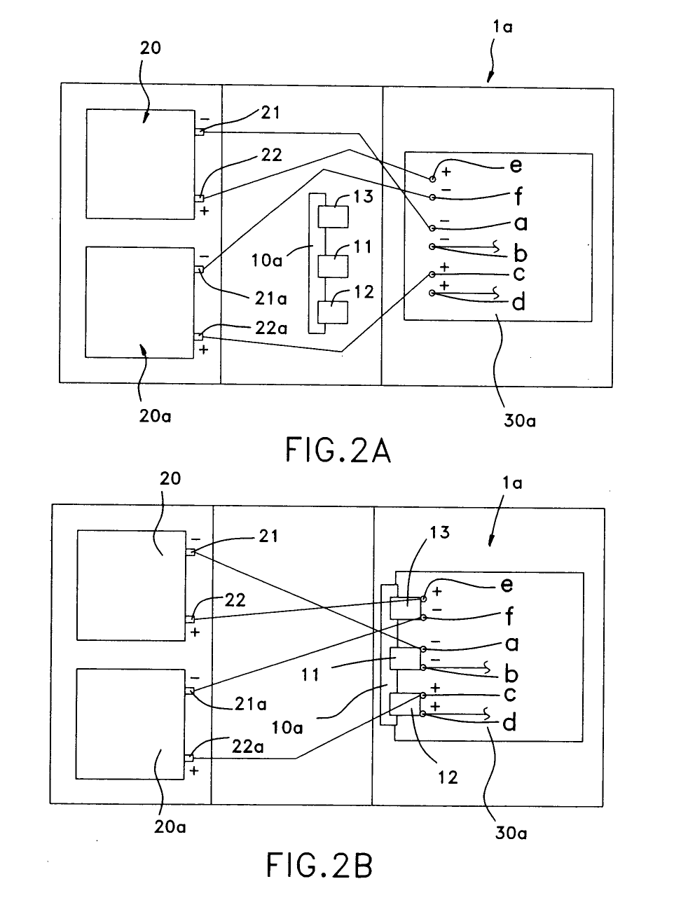

With reference to FIGS. 2A and 2B, an electronic device (1a) an battery module (20) that has two batteries (20a, 20b) to supply added power to a main electric device (30a) has a conductive device (10a) with three conductive switch plates (11, 12, 13). The three conductive switch plates (11, 12, 13) correspond to four null terminals (a, c, e, f) and two circuit terminals (b, d) grouped in pairs on the main electric device (30a). The first null terminal (a) is paired with the negative circuit terminal (b), the second null terminal (c) with the positive circuit terminal (d) as in the previously described main electric device (30). The remaining two null terminals (e, f) are paired together to allow the two batteries (20a, 20b) to be connected in series. Each battery (20a, 20b) has a positive terminal (22a, 22b) and a negative terminal (21a, 21b). One of the remaining null terminals (e, f) is connected to a positive terminal (22b) of one battery (20b), and the other is connected to a negative terminal (21a) of the other battery (20a). When the conductive device (10a) connects to the main electric device (30a), the two batteries (20a, 20b) are safely connected to the main electronic device (30a).

Based on the description, with reference to FIGS. 1A and 1B, the conductive device (10a) with multiple conductive switch plates (11, 12, 13) is used to connect or disconnect the pairs of terminals (a, b, c, d, e, f) on the main electric device (30a). The user can safely disconnect the battery module (20) from the main electronic device (30) and replace the batteries (20a, 20b) after removing the conductive device (10) from the electronic system (1a).

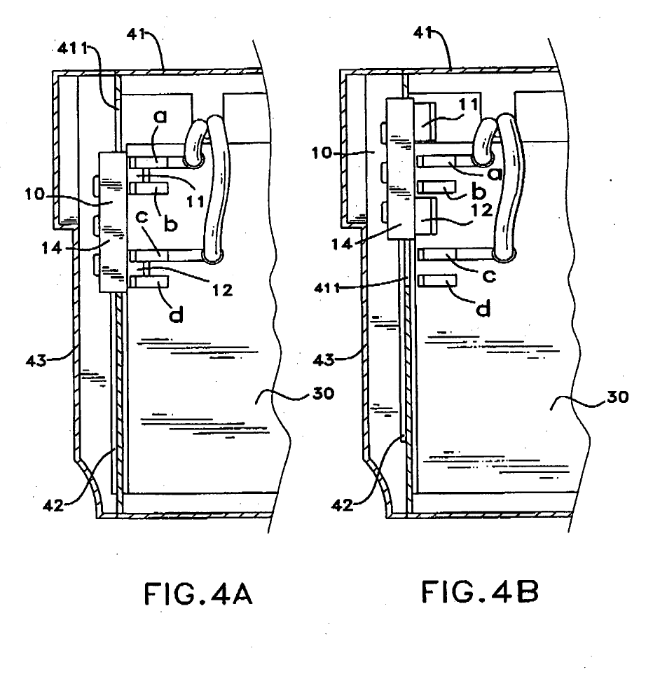

With reference to FIGS. 3, 4A and 4B, the electronic system is an uninterruptible power supply (UPS) (40). In addition to the power source connector (10), the UPS (40) has a case (41), an main electric device (30) having four null and circuit terminals (a, c) (b, d), an battery module (20) having a battery, a front cover (42) and a panel (43).

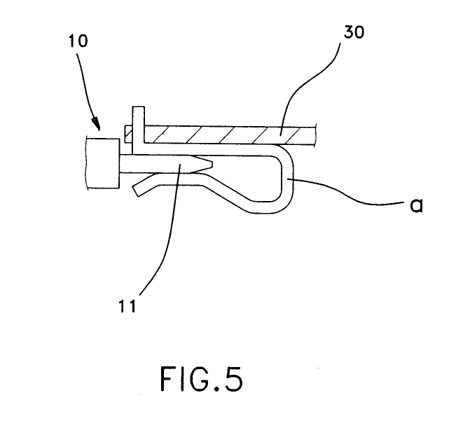

The electric circuit (30) and the battery module (20) are mounted in the case (41). A slot (411) is defined in the case (41) where the null and circuit terminals (a, c) (b, d) of the electronic circuit (30) are mounted in a line. The null terminals (a, c) are connected to two power terminals (21, 22) other battery (20) by wires (not numbered). With reference to FIG. 5, each null or circuit terminal (a) is a resilient U-shaped clip to clip the conductive switch plate (11) of the conductive device (10).

With reference FIG. 3, the battery module (10) has an L-shaped power insulating body (14) having a long side (141) and a short side (142) and two conductive switch plates (11, 12) mounted on the short side (142) of the insulating body (14). The long side (141) of the conductive device (10) is mounted on the front cover (42) with screws (not numbered). The short side (142) of the power source connector (10) protrudes from the front cover (42) to insert into the slot (411) of the case (41) when the front cover (42) is mounted on the case (41).

With reference to FIG. 4A, the two conductive switch plates (11, 12) correspond to the pairs of null and circuit terminals (a, b, c, d) on the main electric device (30). With reference to FIG. 4B, adjacent null and circuit terminals (a, b)(c, d) of each pair are electrically connected through the corresponding conductive switch plate (11, 12) of the conductive device (10). Because the conductive device (10) is mounted on the front cover (42), the front cover (42) is disassembled from the case (41) and then the conductive device (10) also is separated from the main electronic device (30) to disconnect the main electric device (30) from the battery device (20).

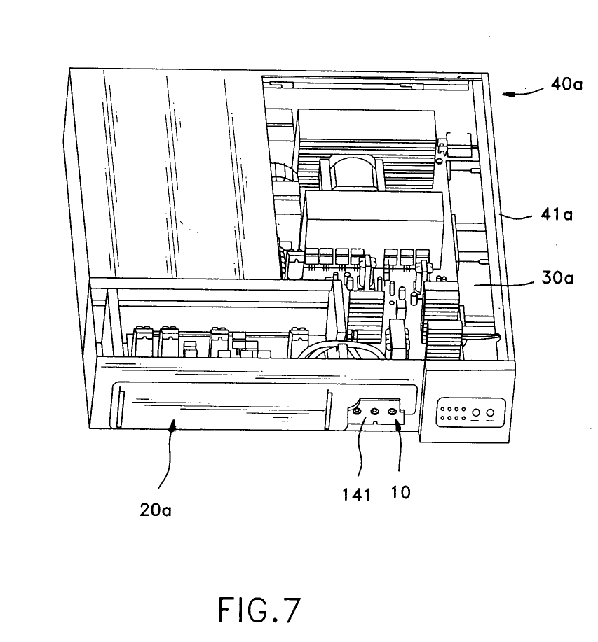

With reference to FIG. 6 and FIG. 7, another electric system (40a) is shown. In this case, the electric system (40a) has a case (41a), an electronic circuit (30a), an exchangeable module (20a) and an extended connector (50a). The main electric device (30a) supplies power to the exchangeable module (20a). The exchangeable module (20a) is connected to terminals on the main electric device (30a) by the extended connector (50a). The long side (141) of the conductive device (10) is mounted on the exchangeable module (20a) and the short side (142) inserts into the case (41) where the electronic circuit (30) mounted. Therefore, each conductive switch plate (11, 12) connects to the corresponding adjacent null and circuit terminals (not shown) on the main electric device (30a). When the exchangeable module (20a) is to be removed from the electronic device (40a), the user can conveniently and safely separate the exchangeable module (20a) and the main electric device (30a) by the extended connector (50a) without reinforced insulation.

Based on the forgoing description, the electronic system use the conductive device without any transformer or protection circuit is used to connect or disconnect an internal power source from the main electric device in the case. Especially a main electric device connected to a high voltage power source in an electronic primary circuit. Consequently, the user does not need to touch the primary circuit to connect or replace the electronic units. Furthermore, the power source connector does not require complex electronic circuit or expensive transformers so the electronic device has a lower cost.

Although the present invention has been explained in relation to its preferred embodiment, it is to be understood that many other possible modifications and variations can be made without departing from the spirit and scope of the invention as hereinafter claimed.

1. An exchangeable module for an electric system, comprising:
a case;
an exchangeable module mounted on the case;
an AC main coupled electric device having multiple null terminals and circuit terminals and mounted in the case, wherein the null terminals are connected to the exchangeable module by a connector;
a conductive device mounted on the exchangeable module and corresponding to the null terminals and the circuit terminals on the AC main coupled electric device, the conductive device being separately connected to the null and circuit terminals on the AC main coupled electric device, whereby the conductive device is used to make or break electric connection between the exchangeable module and the AC main coupled electric device.

2. The exchangeable module as claimed in claim 1, wherein the null terminals and the circuit terminals are alternatively formed on the AC main coupled electric device, and the conductive device comprises:
an insulating body; and
multiple conductive switch plates respectively mounted on the insulating body, wherein each conductive switch plate corresponds to a pair of adjacent null and circuit terminals and electrically connects the pair of adjacent null and the circuit terminals.

3. The exchangeable device as claimed in claim 2, wherein the insulating body is L-shaped having a long side and a short side where the multiple conductive switch plates are mounted.

4. The exchangeable device as claimed in claim 2, wherein a width of one conductive switch plate is larger than a distance the two adjacent null and circuit terminals in a pair.

5. The exchangeable device as claimed in claim 2, wherein either one of the null terminals and the circuit terminals is a resilient clip.

6. The exchangeable device as claimed in claim 3, wherein either one of the null terminals and the circuit terminals is a resilient clip.

7. The exchangeable device as claimed in claim 4, wherein either one of the null terminals and the circuit terminals is a resilient clip.

8. An electric system, comprising:
an AC main coupled electric device retained in a case and having null terminals and circuit terminals; and
an exchangeable module having terminals respectively corresponding to the null terminals, wherein the exchangeable module comprises:
a connector connected between terminals on a body of the exchangeable module and null terminals on the AC main coupled electric device retained in the electric system; and
a conductive device formed on the body to correspond to the null terminals and circuit terminals on the AC main coupled electric device, the conductive device being separately connected to the terminals on the AC main coupled electric device; whereby the conductive device is used to make or break electric connection or disconnection between the exchangeable module and the AC main coupled electric device.

9. The electric system as claimed in claim 8, wherein the null terminals and the circuit terminal are alternatively formed on the AC main coupled electric device, and the conductive device comprises:
an insulating body; and
multiple conductive switch plates respectively mounted on the insulating body, wherein each conductive switch plate corresponds to a pair of adjacent null and circuit terminals and electrically connects the pair of adjacent null and the circuit terminals.

10. The electric system as claimed in claim 9, wherein the insulating body is L-shaped having a long side and a short side where the multiple conductive switch plates are mounted.

11. The electric system as claimed in claim 9, wherein a width of one conductive switch plate is larger than a distance the two adjacent null and circuit terminals in a pair.

12. The electric system as claimed in claim 9, wherein either one of the null terminals and the circuit terminals is a resilient clip.

13. The electric system as claimed in claim 10, wherein either one of the null terminals and the circuit terminals is a resilient clip.

14. The power source connector as claimed in claim 11, wherein either one of the null terminals and the circuit terminals is a resilient clip.

15. An uninterrupted power supply system, comprising:
an AC main coupled electric device retained in a case and having null terminals and circuit terminals; and
a battery module having terminals respectively corresponding to the null terminals, wherein the exchangeable module comprises:
a connector connected between terminals on a battery of the battery module and null terminals on the main coupled electric device retained in the electric system; and
a conductive device formed on the battery to correspond to the null terminals and circuit terminals on the AC main coupled electric device, the conductive device being separately connected to the terminals on the AC main coupled electric device; whereby the conductive device is used to make or break electric connection or disconnection between the battery module and the AC main coupled electric device.

16. The electric system as claimed in claim 15, wherein the null terminals and the circuit terminal are alternatively formed on the AC main coupled electric device, and the conductive device comprises:
an insulating body; and
multiple conductive switch plates respectively mounted on the insulating body, wherein each conductive switch plate corresponds to a pair of adjacent null and circuit terminals and electrically connects the pair of adjacent null and the circuit terminals.

17. The electric system as claimed in claim 16, wherein the insulating body is L-shaped having a long side and a short side where the multiple conductive switch plates are mounted.

18. The electric system as claimed in claim 16, wherein a width of one conductive switch plate is larger than a distance the two adjacent null and circuit terminals in a pair.

19. The electric system as claimed in claim 16, wherein either one of the null terminals and the circuit terminals is a resilient clip.

20. The electric system as claimed in claim 17, wherein either one of the null terminals and the circuit terminals is a resilient clip.
